(19) United States
(12) Patent Application Publication
(10) Pub. No.: US 2011/0040221 A1
(43) Pub. Date: Feb. 17, 2011

(54) System and Method to Reduce Stasis-Induced Reperfusion Injury

(75) Inventors: Amy McNulty, San Antonio, TX (US); Cynthia Miller, San Antonio, TX (US); Leslie Gutierrez, San Antonio, TX (US); Teri Feeley, San Antonio, TX (US); Dan Beniker, San Antonio, TX (US)

Correspondence Address: FULBRIGHT & JAWORSKI L.L.P., 600 CONGRESS AVENUE, SUITE 2400, AUSTIN, TX, 78701, US

(73) Assignee: KCI LICENSING, INC., San Antonio, TX (US)

(21) Appl. No.: 12/855,567

(22) Filed: Aug. 12, 2010

Related U.S. Application Data
(60) Provisional application No. 61/234,348, filed on Aug. 17, 2009.

(51) Int. Cl. A61H 7/00

(52) U.S. Cl. 601/149

(57) ABSTRACT

A system and method for reducing or preventing stasis-induced ischemia reperfusion injury to a tissue. The system and method may vary a pressure exerted on a tissue to generate a physiological response in the tissue. The physiological response may include the production of an antioxidant. The system and method may introduce a pharmacological agent to increase blood flow to the tissue.

### CROSS-REFERENCE TO RELATED APPLICATION

This application claims priority to U.S. Provisional Patent Application Serial No. 61/234,348, filed Aug. 17, 2009 and entitled “System and Method to Reduce Stasis-Induced Reperfusion Injury,” incorporated by reference herein.

### BACKGROUND INFORMATION

The formation of pressure ulcers, also commonly referred to as bedsores, is an ongoing and costly issue in health care worldwide. Ischemia to soft tissues is the major contributor to the formation of pressure ulcers. The compression of the various tissues between a boney prominence of an individual and the support surface they are sitting or lying upon can lead to cell death if the pressure is high over a very short period of time (e.g., sometimes in 1-2 hours) or lower pressures are experienced over a more chronic, extended period of time.

If a patient is admitted to a facility or is incapacitated in the home, the current standard of care for prevention or treatment of pressure ulcers involves repositioning the at-risk patient every two hours to alleviate induced pressure points in any one area. This methodology is cumbersome, involving much labor and effort on the part of the caregiver. In addition, set schedules may be overlooked or may not be optimal for all situations. A severely compromised patient, through advanced age, type of injury, or other secondary illness may require special techniques or schedules to help prevent ulcer formation.

Despite the use of patient turning schedules, special support sleep surfaces and seating surfaces, there are still a significant number of new pressure ulcers that develop each year in the U.S. alone. Statistics indicate that elderly patients admitted to acute care hospitals for nonelective orthopedic procedures, such as hip replacement and treatment of long bone fractures, are at even greater risk of developing pressure ulcers. In addition, persons with spinal cord injury (SCI) and associated comorbidity are also at increased risk.

Systems and methods which address the reduction or prevention of pressure ulcer formation would be of great benefit to the medical community.

### SUMMARY

Exemplary embodiments of the present disclosure comprise systems and methods for reducing or preventing stasis-induced ischemia-reperfusion injury in soft tissues near the surface of a patient (e.g., epidermal tissues). Certain embodiments may comprise mechanical systems and methods configured to condition the tissue to reduce the likelihood that the tissue will experience an ischemia reperfusion injury (IRI). In specific embodiments, a system can be configured to cyclically apply and release pressure to the tissue. Exemplary embodiments may also comprise chemical or pharmacological systems that condition the tissue to reduce the likelihood that it will experience IRI.

In certain embodiments, a mechanical system may cyclically apply and release pressure in the range of 5-35 mm Hg to the soft tissue. This relatively low level of pressure is sufficient to periodically restrict and re-establish blood flow to the tissue (e.g., capillary blood flow). The repeated restriction and re-establishment of blood flow under controlled conditions is believed to cause the tissue to generate responses that can reduce the likelihood of IRI if the tissue is subsequently subjected to pressure for an extended period of time. For example, the repeated restriction and re-establishment of blood flow may cause the production of antioxidants (e.g., glutathione), and/or other chemicals that can reduce the likelihood of IRI if the tissue is subsequently subjected to pressure for extended periods of time.

Exemplary embodiments may comprise chemical or pharmacological agents configured to reduce the likelihood that tissue subjected to pressure for extended periods of time will experience IRI. For example, certain embodiments may include the application of an agent configured to promote dilation of the blood vessels and reduce the likelihood that blood flow is restricted to the point that stasis-induced IRI results. In specific embodiments, adenosine can be applied to the tissue to promote vasodilation.

Exemplary embodiments can be utilized by patients who will be temporarily immobile (e.g., due to surgery) or chronically immobile.

Exemplary embodiments include a system for reducing stasis-induced ischemia reperfusion injury. In specific embodiments, the system may include: a base; a plurality of variable-pressure chambers coupled to the base; a controller configured to control the pressure in the plurality of variable-pressure chambers at a first pressure level greater than 5 mm Hg and at a second pressure level less than 35 mm Hg; and a plurality of pressure sensors configured to provide pressure measurements to the controller.

In certain embodiments, the controller can be configured to cyclically alternate the pressure in the plurality of variable-pressure chambers between the first pressure level and the second pressure level. In particular embodiments, the pressure sensors can be configured to measure pressure in the variable-pressure chambers. In specific embodiments, the pressure sensors can be configured to measure pressure proximal to the variable-pressure chambers.

In particular embodiments, the first pressure level can be between: 5 mm Hg and 25 mm Hg; 5 mm Hg and 15 mm Hg; or 5 mm Hg and 10 mm Hg. In certain embodiments, the second pressure level can be between: 30 mm Hg and 35 mm Hg; 32 mm Hg and 35 mm Hg; or 34 mm Hg and 35 mm Hg.

In specific embodiments, the controller can be configured to control the pressure in the plurality of variable-pressure chambers at the first pressure level for a first period of time greater than 5 seconds and less than 5 minutes. In certain embodiments, the controller can be configured to control the pressure in the plurality of variable-pressure chambers at the second pressure level for a second period of time greater than 5 seconds and less than 5 minutes. In particular embodiments, the first period of time is greater than 30 seconds and less than 4 minutes, and the second period of time is greater than 30 seconds and less than 4 minutes. In specific embodiments, the first period of time is greater than 1 minute and less than 2 minutes, and the second period of time is greater than 1 minute seconds and less than 2 minutes.

In particular embodiments, the controller can be configured to provide compressed air to the plurality of variable-pressure chambers to increase the pressure. In certain embodiments, the controller can be configured to vent air from the plurality of variable-pressure chambers to decrease the pressure. In specific embodiments, the variable-pressure chambers can be configured as expandable tubing.

Certain embodiments comprise a system for reducing stasis-induced ischemia reperfusion injury, where the system can comprise: a base comprising a fluid; a wave generator configured to propagate waves in the fluid; and a controller. Particular embodiments may comprise a pressure sensor configured to measure an interface pressure and provide an interface pressure measurement to the controller, where the controller can be configured to vary the frequency and amplitude of the propagated waves so that the interface pressure is varied between a first pressure level greater than 5 mm Hg and a second pressure level less than 35 mm Hg.

In particular embodiments, the controller can be configured to vary the frequency and amplitude of the propagated waves so that a variation in interface pressure generates a physiological response capable of reducing a stasis-induced ischemia reperfusion injury to a soft tissue engaged with the base. In specific embodiments, the physiological response can be the production of an antioxidant. In certain embodiments, the antioxidant is glutathione.

Specific embodiments can include a system for reducing stasis-induced ischemia reperfusion injury, where the system comprises: a base comprising a fluid; and a controller configured to generate bubbles in the fluid. The system may also comprise a pressure sensor configured to measure an interface pressure and provide an interface pressure measurement to the controller, where the controller is configured to vary an amount of the bubbles so that the interface pressure can be varied between a first pressure level greater than 5 mm Hg and a second pressure level less than 35 mm Hg. In particular embodiments, the controller can be configured to generate bubbles via the release of compressed air.

Certain embodiments can include a system for reducing stasis-induced ischemia reperfusion injury, where system comprises: a base; a plurality of cams; and a controller configured to rotate the cams. The system may also comprise a pressure sensor configured to measure an interface pressure and provide an interface pressure measurement to the controller, where the controller can be configured to rotate the cams so that the interface pressure can be varied between a first pressure level greater than 5 mm Hg and a second pressure level less than 35 mm Hg. In particular embodiments, the controller may comprise a timing device to control the duration that the interface pressure is maintained at a specific pressure between the first pressure level and the second pressure level.

Certain embodiments may include a method of reducing stasis-induced ischemia reperfusion injury, where the method comprises: providing a base material comprising a pharmacological agent configured to promote vasodilation; placing the base material on or over a boney protuberance; and dilating a blood vessel and increasing blood flow to soft tissue proximal to the boney protuberance. In specific embodiments, the pharmacological agent may comprise adenosine.

Particular embodiments may include a method of reducing stasis-induced ischemia reperfusion injury, where the method comprises: (a) exerting a pressure on a soft tissue proximal to an epidermis at a first pressure level sufficient to restrict blood flow to the soft tissue for a first period of time; (b) reducing the pressure on the soft tissue proximal to the epidermis to a second pressure level sufficient to allow blood flow to the epidermal tissue for a second period of time; and (c) repeating steps (a) and (b) so that the soft tissue generates a physiological response capable of reducing a stasis-induced ischemia reperfusion injury to the soft tissue. In certain embodiments, the physiological response can be the production of an antioxidant. In particular embodiments, the antioxidant may be glutathione.

In certain embodiments, the first pressure level may be between: 5 mm Hg and 25 mm Hg; 5 mm Hg and 15 mm Hg; 5 mm Hg and 10 mm Hg. In particular embodiments, the second pressure level may be between: 30 mm Hg and 35 mm Hg; 32 mm Hg and 35 mm Hg; or 34 mm Hg and 35 mm Hg. In specific embodiments, the first period of time may be greater than 5 seconds and less than 5 minutes. In particular embodiments, the second period of time may be greater than 5 seconds and less than 5 minutes.

### BRIEF DESCRIPTION OF THE FIGURES

While exemplary embodiments of the present invention have been shown and described in detail below, it will be clear to the person skilled in the art that changes and modifications may be made without departing from the scope of the invention. As such, that which is set forth in the following description and accompanying drawings is offered by way of illustration only and not as a limitation. The actual scope of the invention is intended to be defined by the following claims, along with the full range of equivalents to which such claims are entitled.

In addition, one of ordinary skill in the art will appreciate upon reading and understanding this disclosure that other variations for the invention described herein can be included within the scope of the present invention.

In the following Detailed Description of Disclosed Embodiments, various features are grouped together in several embodiments for the purpose of streamlining the disclosure. This method of disclosure is not to be interpreted as reflecting an intention that exemplary embodiments of the invention require more features than are expressly recited in each claim. Rather, as the following claims reflect, inventive subject matter lies in less than all features of a single disclosed embodiment. Thus, the following claims are hereby incorporated into the Detailed Description of Exemplary Embodiments, with each claim standing on its own as a separate embodiment.

FIG. 1 is a perspective view of one non-limiting, exemplary embodiment of a pad system.

FIG. 2 is a perspective view of one non-limiting, exemplary embodiment of a pad system.

FIG. 3 is a perspective view of one non-limiting, exemplary embodiment of a pad system.

FIG. 4 is a perspective view of one non-limiting, exemplary embodiment of a pad system.

FIG. 5 is a perspective view of one non-limiting, exemplary embodiment of a pad system.

FIG. 6 is a perspective view of one non-limiting, exemplary embodiment of a pad system.

FIG. 7 is a flowchart of one non-limiting, exemplary embodiment of a method of reducing stasis-induced reperfusion injury.

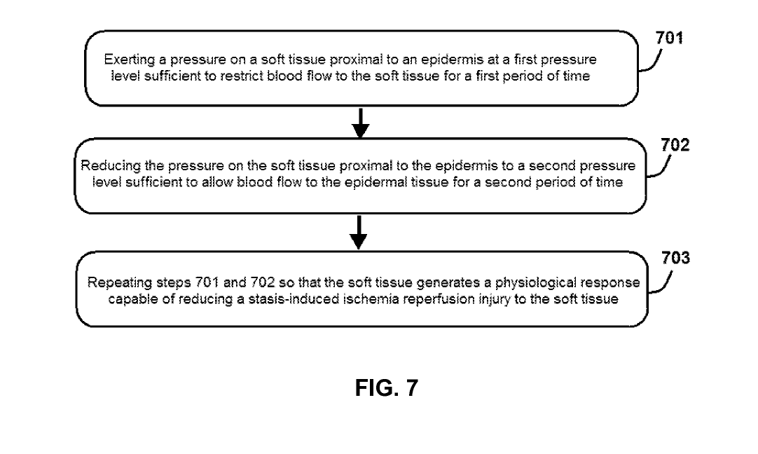

### DETAILED DESCRIPTION OF EXEMPLARY EMBODIMENTS

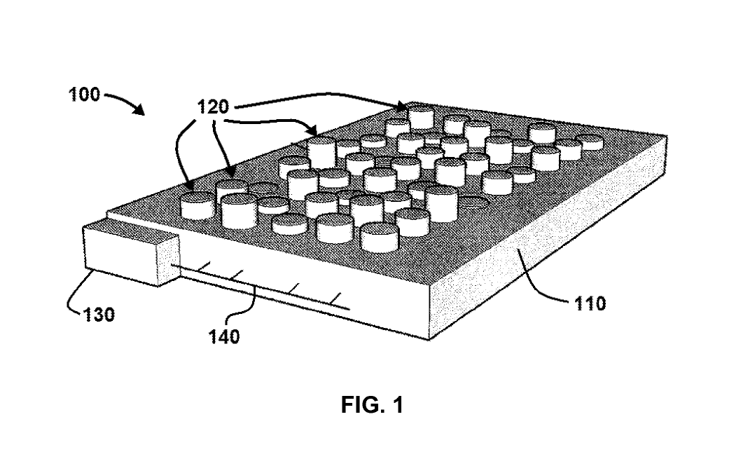

Referring now to the exemplary embodiment shown in FIG. 1, a system 100 comprises a base 110, a plurality of variable-pressure chambers 120 and a controller 130. In this embodiment, controller 130 is coupled (e.g., via a pneumatic or hydraulic coupling) to variable-pressure chambers 120 via conduit 140. Controller 130 is configured to increase and decrease the pressure between approximately 5 mm Hg and 35 mm Hg. In certain exemplary embodiments, controller 130 comprises a pump or compressor configured to increase the pressure of a fluid contained within variable-pressure chambers 120. System 100 can also comprise pressure sensors (not shown for purposes of clarity) proximal to or within variable-pressure chambers 120 to provide pressure measurements to controller 130. In certain embodiments, pressure sensors can measure the interface pressure between system 100 and a person being supported by system 100.

In specific exemplary embodiments, controller 130 comprises an air compressor and a programmable-logic-controller (PLC) configured to provide compressed air to the plurality of variable-pressure chambers. Controller 130 can provide compressed air to the plurality of variable-pressure chambers when it is desirable to increase the pressure. Controller 130 may also be coupled to a plurality of vents (not shown) that can be manipulated to release pressure from the plurality of variable-pressure chambers 120 when it is desirable to reduce the pressure in the variable-pressure chambers 120. While variable-pressure chambers 120 are shown in a cylindrical configuration in this embodiment, it is understood that other exemplary embodiments may comprise variable-pressure chambers may comprise different configurations, including for example, hemispherical.

In certain embodiments, base 110 comprises a material configured to minimize interface pressures between system 100 and a patient. For example, base 110 may comprise a thin, flexible material that readily conforms to a patient's epidermis. Base 110 may comprise a compressible material such as an open-cell foam material that deforms when supporting the weight of the patient.

In certain embodiments, variable-pressure chambers 120 may be coupled together so that multiple variable-pressure chambers are in fluid communication with each other. In such embodiments, a single pressure sensor may be used to monitor the pressure of a group of variable-pressure chambers. In certain embodiments, a row or column (e.g., a linear arrangement of variable-pressure chambers) may be grouped together. In other embodiments, variable-pressure chambers 120 may be grouped together in other patterns (e.g., circular, rectangular, etc.).

During use, system 100 can be placed so that base 110 and variable-pressure chambers 120 engage or support the epidermis of a patient. It is understood that variable-pressure chambers 120 need not directly contact the epidermis in order to engage or support the epidermis. For example, variable-pressure chambers 120 may engage or support the epidermis through a coverlet and/or through the patient's clothing.

System 100 can be operated so that the pressure in variable-pressure chambers 120 is increased and decreased, which leads to an increase and decrease in the interface pressure between the variable-pressure chambers 120 and the patient's epidermis. In specific embodiments, the pressure is varied between approximately 5 mm Hg and 35 mm Hg. It is understood that exemplary embodiments may include other pressure ranges necessary to induce a specific physiological response. In exemplary embodiments, the induced physiological response reduces the likelihood that the soft tissue will be subjected to a stasis-induced ischemia reperfusion injury when the tissue is subjected to increased pressure for extended periods of time. In specific embodiments, the induced physiological response is the production of an antioxidant (e.g., glutathione) in the soft tissue proximal to the epidermis of the patient.

In exemplary embodiments, the pressure can be increased and decreased in a cyclic pattern. For example, the pressure may be increased to a pressure near the upper end of the range (e.g., between approximately 25 and 35mm Hg) and held there for a specific duration. In specific embodiments, the upper end of the pressure range is (in mm Hg): 25, 26, 27, 28, 29, 30, 31, 32, 33, 34, or 35.

In certain embodiments, the duration that the pressure is increased to this range may last for 5, 10, 20, 30, 40, 50 or 60 seconds. In other embodiments, the duration that the pressure is increased to this range may last for 1, 2, 3, 4, 5, 6, 7, 8, 9, or 10 minutes.

After the pressure is increased for a specific duration, controller 130 can reduce the pressure to a pressure near the lower end of the range (e.g. 5-10 mm Hg). In specific embodiments, the lower end of the pressure range is (in mm Hg): 5, 6, 7, 8, 9, 10. In other embodiments, the lower end of the pressure range is (in mm Hg): 11, 12, 13, 14, 15, 16, 17, 18, 19, 20, 21, 22, 23, 24, 25, 26, 27, 28, 29, or 30. In certain embodiments, the duration that the pressure is decreased to this range may last for 5, 10, 20, 30, 40, 50 or 60 seconds. In other embodiments, the duration that the pressure is decreased to this range may last for 1, 2, 3, 4, 5, 6, 7, 8, 9, or 10 minutes.

In certain embodiments, base 110 is configured to extend across a mattress surface so that a patient's entire body is supported by base 110. In other embodiments, base 110 can be configured so that it extends across a specific portion of a patient. For example, base 110 can be configured so that it extends across a boney protuberance such as an elbow, hip, knee or heel of a patient. In certain embodiments, system 100 may comprise multiple bases with variable-pressure chambers coupled to a single controller. In such embodiments, a base with variable-pressure chambers can be placed under each specific location of the patient in which it is desired to stimulate a physiological response to reduce the likelihood of stasis-induced IRI (e.g., the production of antioxidants).

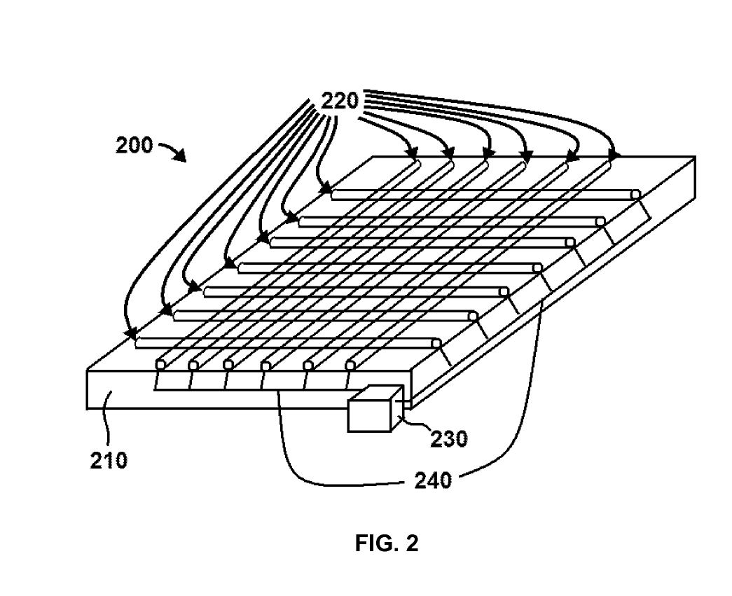

Referring now to the exemplary embodiment shown in FIG. 2, a system 200 comprises a base 210, a plurality of variable-pressure chambers 220 and a controller 230. In this embodiment, controller 230 is coupled (e.g., via a pneumatic, hydraulic, or electrical coupling) to variable-pressure chambers 220 via conduit 240. In the embodiment shown in FIG. 2, variable-pressure chambers 220 can be configured as expandable tubing. In certain embodiments, base 210 can be configured as a mattress, cushion, coverlet, or other substantially planar formation into which a network of expandable tubing is embedded. System 200 can also comprise pressure sensors (not shown for purposes of clarity) proximal to or within variable-pressure chambers 220 to provide pressure measurements to controller 230.

System 200 operates in a manner generally equivalent to that described for system 100. For example, controller 230 can increase and decrease the pressure within variable-pressure chambers 220 in order to stimulate a desired physiological response (e.g., the production of an antioxidant) in tissue proximal to variable-pressure chambers. In certain embodiments, the expandable tubing may comprise expandable accumulators to provide additional volume for variable-pressure chambers 220.

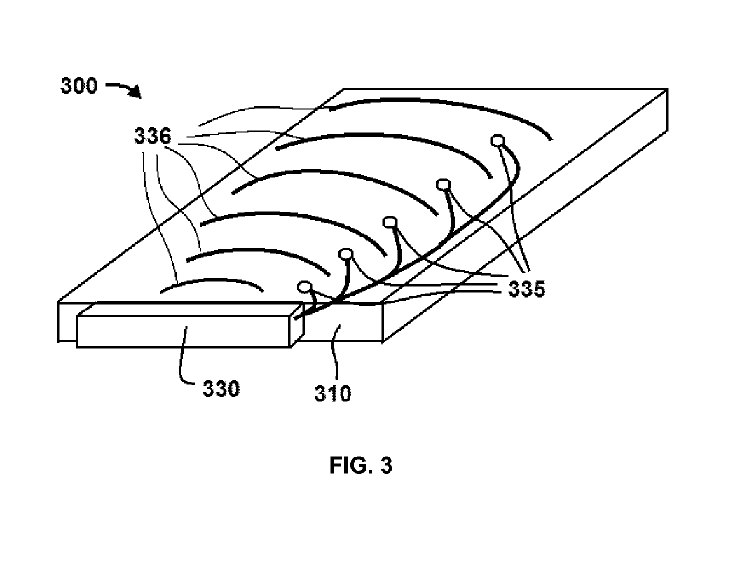

Referring now to the exemplary embodiment shown in FIG. 3, a system 300 comprises a base 310 a controller 330. In this embodiment, base 310 can be configured as a fluid-filled volume (e.g., a mattress or cushion). In this embodiment, controller 330 may comprise a wave generator configured to generate or propagate waves 336 through the fluid contained within base 310.

In specific embodiments, controller 330 can be configured to generate sound waves propagated through the fluid to create wave fronts or standing waves at the interface between base 310 and a person supported by system 300. The frequency and amplitude of the propagated waves can be varied by controller 330 to alter the pressure exerted on the supported person. In certain embodiments, the pressure can be increased and decreased in order to stimulate a desired physiological response (e.g., the production of an antioxidant) in tissue supported by base 310. In the embodiment shown, system 300 comprises one or more pressure sensors 335 configured to provide interface pressure measurements (e.g., measurements of the pressure between base 310 and a person being supported by base 310) to controller 330.

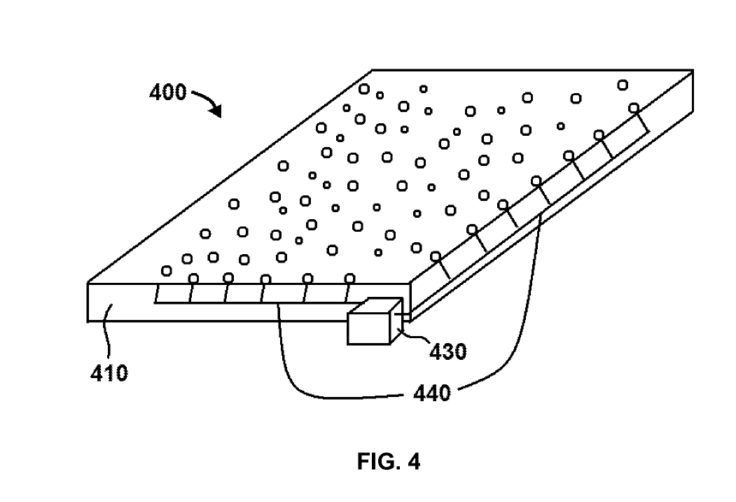

Referring now to the exemplary embodiment shown in FIG. 4, a system 400 comprises a controller 430 and a base 410 containing a fluid (e.g., water). In this embodiment, controller 430 is configured to generate bubbles 435 (e.g. gas encapsulated in the fluid) that are propagated through the reservoir. The bubbles may be generated via the release of compressed air into the reservoir or other suitable mechanisms, including for example, micro-fluidic mechanisms. In the embodiment shown, system 400 comprises a conduit 440 configured to distribute bubbles 435.

System 400 can also comprise a plurality of pressure sensors (not shown for purposes of clarity) configured to provide pressure measurements to controller 430. The propagation of bubbles 435 through base 410 can be used to control the pressure exerted on a person being supported by reservoir. For example, if the desired pressure is lower than the measured pressure, controller 430 may increase the amount of bubbles (e.g., the size and/or quantity of bubbles) being propagated through base 410. In certain embodiments, the pressure can be increased and decreased in order to stimulate a desired physiological response (e.g., the production of an antioxidant) in tissue supported by base 410.

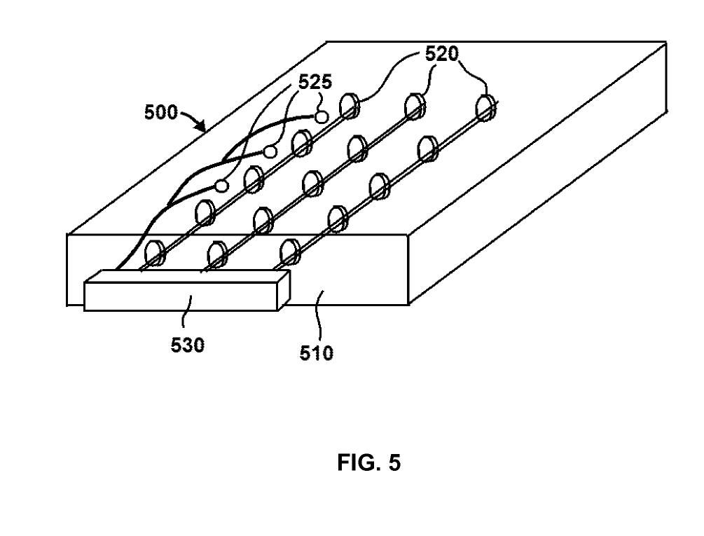

Referring now to the exemplary embodiment shown in FIG. 5, a system 500 comprises a base 510 and a plurality of rotating cams 520 configured to vary the interface pressure exerted against a patient being supported by system 500. In the embodiment shown, system 500 comprises a controller 530 configured to control the rotation of cams 520. The eccentric shape of cams 520 causes the cams to exert a higher pressure against a person being supported by system 500 when an elongated portion of the cams (e.g., the portion of the cams facing upward in the position shown in FIG. 5) is directed toward the patient.

Controller 530 can also rotate cams 520 so that the elongated portion of the cams are directed away from the patient (e.g., 180 degrees from the position shown in FIG. 5). When cams 520 are positioned 180 degrees from the position shown in FIG. 5, the cams can exert a lower pressure against a person being supported by system 500. The pressure exerted on specific locations of a person may also be affected by having different cams in different positions (e.g., some cams facing up and some cams facing down). In certain embodiments, the pressure can be increased and decreased in order to stimulate a desired physiological response (e.g., the production of an antioxidant) in tissue supported by base 510.

System 500 can also comprise one or more pressure sensors 525 configured to measure an interface pressure, e.g. the pressure near the interface between system 500 and a person being supported by system 500. Sensors 525 can provide feedback to controller 530 so that the position of cams 520 can be positioned to provide the desired pressure between system 500 and a supported person. Controller 530 may also comprise a timing device to control the duration that system 500 exerts a specified pressure on a supported person.

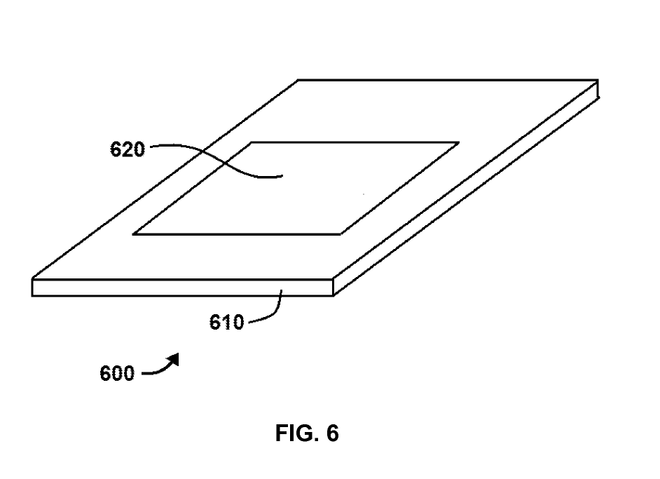

Referring now to the exemplary embodiment shown in FIG. 6, a system 600 comprises a base material 610 comprising a chemical or pharmacological agent 620. In the embodiment shown, base material 610 can comprise a wrap or bandage and pharmacological agent 620 may be contained in a pad or gauze-type material.

In exemplary embodiments, pharmacological agent 620 can be configured to reduce the likelihood that tissue subjected to pressure for extended periods of time will experience IRI. For example, pharmacological agent 620 can be configured to promote dilation of the blood vessels and reduce the likelihood that blood flow is restricted to the point that stasis-induced IRI results upon application of pressure for extended periods of time. In a specific exemplary embodiment, pharmacological agent 620 comprises adenosine. System 600 can be applied to specific locations (e.g., boney protuberances) in which stasis-induced IRI may be likely.

1. A system for reducing stasis-induced ischemia reperfusion injury, the system comprising:
a base;
a plurality of variable-pressure chambers coupled to the base;
a controller configured to control the pressure in the plurality of variable-pressure chambers at a first pressure level greater than 5 mm Hg and at a second pressure level less than 35 mm Hg; and
a plurality of pressure sensors configured to provide pressure measurements to the controller.

2. The system of claim 1 wherein the controller is configured to cyclically alternate the pressure in the plurality of variable-pressure chambers between the first pressure level and the second pressure level.

3. The system of claim 1 wherein the pressure sensors are configured to measure pressure in the variable-pressure chambers.

4. The system of claim 1 wherein the pressure sensors are configured to measure pressure proximal to the variable-pressure chambers.

5. The system of claim 1 wherein the first pressure level is between 5 mm Hg and 25 mm Hg.

6. The system of claim 1 wherein the first pressure level is between 5 mm Hg and 15 mm Hg.

7. The system of claim 1 wherein the first pressure level is between 5 mm Hg and 10 mm Hg.

8. The system of claim 1 wherein the second pressure level is between 30 mm Hg and 35 mm Hg.

9. The system of claim 1 wherein the second pressure level is between 32 mm Hg and 35 mm Hg.

10. The system of claim 1 wherein the second pressure level is between 34 mm Hg and 35 mm Hg.

11. The system of claim 1 wherein the controller is configured to control the pressure in the plurality of variable-pressure chambers at the first pressure level for a first period of time greater than 5 seconds and less than 5 minutes and wherein the controller is configured to control the pressure in the plurality of variable-pressure chambers at the second pressure level for a second period of time greater than 5 seconds and less than 5 minutes.

12. The system of claim 11 wherein the first period of time is greater than 30 seconds and less than 4 minutes and wherein the second period of time is greater than 30 seconds and less than 4 minutes.

13. The system of claim 11 wherein the first period of time is greater than 1 minute and less than 2 minutes and wherein the second period of time is greater than 1 minute seconds and less than 2 minutes.

14. The system of claim 1, wherein the controller is configured to provide compressed air to the plurality of variable-pressure chambers to increase the pressure.

15. The system of claim 1, wherein the controller is configured to vent air from the plurality of variable-pressure chambers to decrease the pressure.

16. The system of claim 1 wherein the variable-pressure chambers are configured as expandable tubing.

17. A system for reducing stasis-induced ischemia reperfusion injury, the system comprising:
a base comprising a fluid;
a wave generator configured to propagate waves in the fluid;
a controller; and
a pressure sensor configured to measure an interface pressure and provide an interface pressure measurement to the controller, wherein the controller is configured to vary the frequency and amplitude of the propagated waves so that the interface pressure is varied between a first pressure level greater than 5 mm Hg and a second pressure level less than 35 mm Hg.

18. The system of claim 17 wherein the controller is configured to vary the frequency and amplitude of the propagated waves so that a variation in interface pressure generates a physiological response capable of reducing a stasis-induced ischemia reperfusion injury to a soft tissue engaged with the base.

19. The system of claim 18 wherein the physiological response is the production of an antioxidant.

20. The system of claim 19 wherein the antioxidant is glutathione.

21. A system for reducing stasis-induced ischemia reperfusion injury, the system comprising:
a base comprising a fluid;
a controller configured to generate bubbles in the fluid; and
a pressure sensor configured to measure an interface pressure and provide an interface pressure measurement to the controller, wherein the controller is configured to vary an amount of the bubbles so that the interface pressure is varied between a first pressure level greater than 5 mm Hg and a second pressure level less than 35 mm Hg.

22. The system of claim 21 wherein the controller is configured to generate bubbles via the release of compressed air.

23. A system for reducing stasis-induced ischemia reperfusion injury, the system comprising:
a base;
a plurality of cams;
a controller configured to rotate the cams;
a pressure sensor configured to measure an interface pressure and provide an interface pressure measurement to the controller, wherein the controller is configured to rotate the cams so that the interface pressure is varied between a first pressure level greater than 5 mm Hg and a second pressure level less than 35 mm Hg.

24. The system of claim 23 wherein the controller comprises a timing device to control the duration that the interface pressure is maintained at a specific pressure between the first pressure level and the second pressure level.

25. A method of reducing stasis-induced ischemia reperfusion injury, the method comprising:
providing a base material comprising a pharmacological agent configured to promote vasodilation;
placing the base material on or over a boney protuberance; and
dilating a blood vessel and increasing blood flow to soft tissue proximal to the boney protuberance.

26. The method of claim 25 wherein the pharmacological agent comprises adenosine.

27. A method of reducing stasis-induced ischemia reperfusion injury, the method comprising:
(a) exerting a pressure on a soft tissue proximal to an epidermis at a first pressure level sufficient to restrict blood flow to the soft tissue for a first period of time;
(b) reducing the pressure on the soft tissue proximal to the epidermis to a second pressure level sufficient to allow blood flow to the epidermal tissue for a second period of time; and
(c) repeating steps (a) and (b) so that the soft tissue generates a physiological response capable of reducing a stasis-induced ischemia reperfusion injury to the soft tissue.

28. The method of claim 27 wherein the physiological response is the production of an antioxidant.

29. The method of claim 28 wherein the antioxidant is glutathione.

30. The method of claim 27 wherein the first pressure level is between 5 mm Hg and 25 mm Hg.

31. The method of claim 27 wherein the first pressure level is between 5 mm Hg and 15 mm Hg.

32. The method of claim 27 wherein the first pressure level is between 5 mm Hg and 10 mm Hg.

33. The method of claim 27 wherein the second pressure level is between 30 mm Hg and 35 mm Hg.

34. The method of claim 27 wherein the second pressure level is between 32 mm Hg and 35 mm Hg.

35. The method of claim 27 wherein the second pressure level is between 34 mm Hg and 35 mm Hg.

36. The method of claim 27 wherein the first period of time is greater than 5 seconds and less than 5 minutes.

37. The method of claim 27 wherein the second period of time is greater than 5 seconds and less than 5 minutes.
